(19) United States
(12) Patent Application Publication
(10) Pub. No.: US 2014/0161389 A1
(43) Pub. Date: Jun. 12, 2014

(54) APPARATUS FOR CONNECTING OPTICAL FIBER

(71) Applicant: ELECTRONICS AND TELECOMMUNICATIONS RESEARCH INSTITUTE, (US)

(72) Inventors: Seong Yong JUNG, Gwangju (KR); Young Soon HEO, Gwangju (KR); Seihyoung LEE, Gwangju (KR); Hyun Seo KANG, Gwangju (KR); Young Sun KIM, Daejeon (KR)

(73) Assignee: ELECTRONICS AND TELECOMMUNICATIONS RESEARCH INSTITUTE, Daejeon (KR)

(21) Appl. No.: 13/872,425

(22) Filed: Apr. 29, 2013

(30) Foreign Application Priority Data
Dec. 10, 2012 (KR) 10-2012-0142912

(51) Int. Cl. G02B 6/38

(52) U.S. Cl. CPC G02B 6/3825
USPC 385/24; 385/60; 385/61

(57) ABSTRACT

Provided is an apparatus for connecting optical fiber. The apparatus for connecting optical fiber includes an input terminal in which an input optical fiber receiving light is inserted through an input ferrule, an output terminal emitting the light incident through the input optical fiber into an outer optical fiber through an output ferrule, and a module coupling unit connecting the input terminal to the output terminal.

### CROSS-REFERENCE TO RELATED APPLICATIONS

This U.S. non-provisional patent application claims priority under 35 U.S.C. §119 of Korean Patent Application No. 10-2012-0142912, filed on Dec. 10, 2012, the entire contents of which are hereby incorporated by reference.

### BACKGROUND OF THE INVENTION

The present invention disclosed herein relates to a sun light transmission system, and more particularly, to an optical fiber connection apparatus that connects, couples, and distributes solar light by using optical fibers.

With the acceleration of economic development, technologies for collecting solar light to compensate the lack of sunlight due to environmental pollution, energy saves, high-rise buildings, integrated buildings, and the like are being emphasized as novel alternatives. In a case where the solar light collection technologies are applied to the lightings, natural lighting may be supplied in the daytime to save electric charges. Furthermore, in a case where the solar light collection technologies are applied to the underground spaces, sunlight may be supplied to sterilize, disinfect, purify, and dry the underground spaces, thereby providing the pleasant environment to the occupants. As a result, the occupants live in a restful atmosphere. In addition, it may prevent the occupants from being infected with various diseases such as depression due to the lack of the time exposed to sunlight for the occupants living in the underground spaces. Also, the solar light may have superior color rendering when compared to those of artificial light sources (e.g., fluorescent lights, incandescent lamps, light emitting diodes (LEDs), and the like) to improve indoor environments.

There is an optical fiber-type solar light collection system that is one of solar light collection systems using the solar light collection technologies. The optical fiber-type solar light collection system may use a plurality of optical cables to transmit light to a long distance. However, since the solar light transmission optical cables used in the optical fiber-type solar light collection system are expensive, costs required for transmitting light by using the plurality of optical cables may increase.

### SUMMARY OF THE INVENTION

The present invention provides an optical fiber connection apparatus transmitting solar light by using optical fibers.

The present invention also provides an optical fiber connection apparatus which connects, couples, and distributes solar light to transmit the solar light between optical fibers.

The present invention also provides an optical fiber connection apparatus in which optical cables constituted by optical fibers are easily connected to and separated from each other.

Embodiments of the present invention provide apparatuses for connecting an optical fiber, the apparatuses including an input terminal in which an input optical fiber receiving light is inserted through an input ferrule; an output terminal emitting the light incident through the input optical fiber into an outer optical fiber through an output ferrule; and a module coupling unit connecting the input terminal to the output terminal.

In some embodiments, the input optical fiber may be inserted into the input ferrule having a cylindrical structure, and the output optical fiber may be inserted into the out ferrule having a cylindrical structure.

In other embodiments, the input terminal may include: an input lens defining a focus of the light emitted through the input optical fiber; and a ferrule lens coupling guide connecting the input ferrule to the input lens.

In still other embodiments, a focus space may be defined between the input ferrule and the input lens.

In even other embodiments, the output terminal may include: an output lens defining a focus through which the light is transmitted into the output optical fiber; and a ferrule lens coupling guide connecting the output lens to the output ferrule.

In yet other embodiments, a focus space may be defined between the output ferrule and the output lens.

In further embodiments, the apparatuses may further include: a module lower structure coupling the input lens to the output lens; and a main module coupling the ferrule lens coupling guides of the input terminal and the output terminal to each other.

In still further embodiments, the module coupling unit may include an optical waveguide which, when at least two input terminals are provided, couples light received through the input terminals to emit the coupled light into the output terminal, and when at least two output terminals are provided, distributes the light received through the input terminal to emit the distributed light into the output terminals.

In even further embodiments, the optical waveguide may have a Y-shape.

In yet further embodiments, the module coupling unit may further include: a module lower structure coupling the lens of the input terminal, the lens of the output terminal, and the optical waveguide to each other; and a main module coupling the module lower structure to the ferrule lens coupling guides of the input and output terminals.

In much further embodiments, the module coupling unit may include a distribution filter which, when at least two output terminals are provided, distributes light received through the output terminals to emit the distributed light into the output terminal.

In still much further embodiments, the module coupling unit may further include: a module lower structure coupling the lens of the input terminal, the lens of the output terminal, and the distribution filter to each other; and a main module coupling the module lower structure to the ferrule lens coupling guides of the input and output terminals.

In even much further embodiments, the optical fiber may include a large-core optical fiber.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view of an optical fiber connection apparatus connecting optical fibers according to an embodiment of the present invention;

FIG. 2 is a view of an optical fiber connection apparatus coupling and distributing optical fibers according to an embodiment of the present invention; and

FIG. 3 is a view of an optical fiber connection apparatus distributing solar-light emitted from an optical fiber according to an embodiment of the present invention.

### DETAILED DESCRIPTION OF PREFERRED EMBODIMENTS

Preferred embodiments of the present invention will be described below in more detail with reference to the accompanying drawings. It should be noted that only necessary parts for comprehending operations according to the present invention will be described below, and descriptions with respect to units except for the necessary parts will be omitted to avoid ambiguous interpretation of the present invention.

The present invention provides an apparatus for connecting an optical fiber (hereinafter, referred to as an optical fiber connection apparatus). Here, the optical fiber may include, for example, a large-core optical fiber. The optical fiber connection apparatus of the present invention may be implemented to function as exclusive apparatuses for optical connection, optical distribution-coupling and optical distribution to transmit light emitted through an optical fiber to other optical fibers.

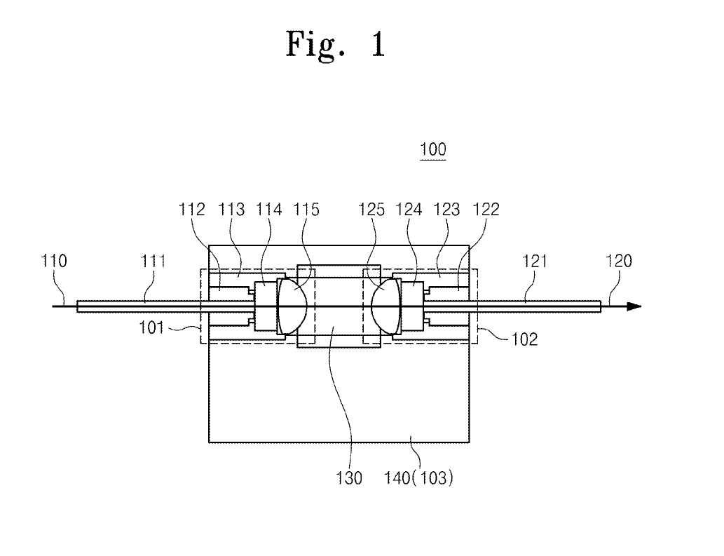

FIG. 1 is a view of an optical fiber connection apparatus connecting the optical fibers according to an embodiment of the present invention.

Referring to FIG. 1, an optical fiber connection apparatus 100 connects a first optical fiber 111 to a second optical fiber 121. Light 110 incident through the first optical fiber 111 and light 120 emitted through the second optical fiber 121 are shown in FIG. 1. Here, the first optical fiber 111 and the second optical fiber 121 may be provided with large-core optical fibers, respectively. The first optical fiber 111 may be an input optical fiber that receives light, and the second optical fiber 121 may be an output optical fiber that emits light.

The optical fiber connection apparatus 100 may include an input terminal 101, an output terminal 102, and a module coupling unit 103.

The input terminal 101 may include a first ferrule 112, a first ferrule lens coupling guide 113, a first focus space 114, and a first lens 115.

The first ferrule 112 is used to align core wires of the first optical fiber 111. The first ferrule 112 should have high deformation resistance to maintain its proper shape. Thus, the first ferrule 112 may be formed of stainless steel, polymer, or ceramic (e.g. aluminum oxide or zirconium oxide). Here, since the first optical fiber 111 is inserted into the first ferrule 112, and then the first ferrule 112 receives light through the first optical fiber 111, the first ferrule 112 may be an input ferrule.

The first ferrule lens coupling guide 113 may couple the first ferrule 112 to the first lens 115.

The first focus space 114 may be a space defined between the first ferrule 112 and the first lens 115. The first focus space 114 may be a space for transmitting light emitted from the first optical fiber 111 to the first lens 115 to define a focus by using the first lens 115.

The first lens 115 may concentrate light incident through the first focus space 114 to define a focus. The first lens 115 may emit light incident from the first optical fiber through the defined focus. Since the first lens 115 is disposed in the input terminal 101, the first lens 115 may be an input lens.

The output terminal 102 may include a second ferrule 122, a second ferrule lens coupling guide 123, a second focus space 124, and a second lens 125.

The second lens 125 may receive light emitted and scattered from the first lens 115. The light scattered through the second lens 125 may be focused. Since the second lens 125 is disposed in the output terminal 102, the second lens 125 may be an output lens.

The second focus space 124 may be a space defined between the second lens 125 and the second ferrule 122. The second focus space 124 may be a space for transmitting the light focused by the second lens 125 to the second optical fiber 121.

The second ferrule lens coupling guide 123 may couple the second ferrule 122 to the second lens 125.

The second ferrule 122 is used to align core wires of the second optical fiber 121. The second ferrule 122 should have high deformation resistance to maintain its proper shape. Thus, the second ferrule 122 may be formed of stainless steel, polymer, or ceramic (e.g. aluminum oxide or zirconium oxide). Here, since the second optical fiber 121 is inserted into the second ferrule 122, and then the second ferrule 122 emits light into the second optical fiber 121, the second ferrule may be an output ferrule.

The module coupling unit 103 may include a module lower structure 130 and a main module 140. The module coupling unit 103 may include the rest units of the optical fiber connection apparatus 100 except for the input terminal 101 and the output terminal 102.

The module lower structure 130 may function to support the connection between the lens 115 and 125. That is, the lens 115 and 125 may be coupled to or disposed on the module lower structure 130.

The main module 140 may package the first and second ferrule lens coupling guides 113 and 123 and the module lower structure 130.

Here, the optical fiber connection apparatus 100 may function as an optical connection module that receives or emits light at a one-to-one ratio therethrough. Thus, the optical fiber connection apparatus 100 may be provided with at least two outputs to correspond to at least two inputs, thereby realizing a one-to-one input/output ratio therethrough, and also may function as the optical connection module.

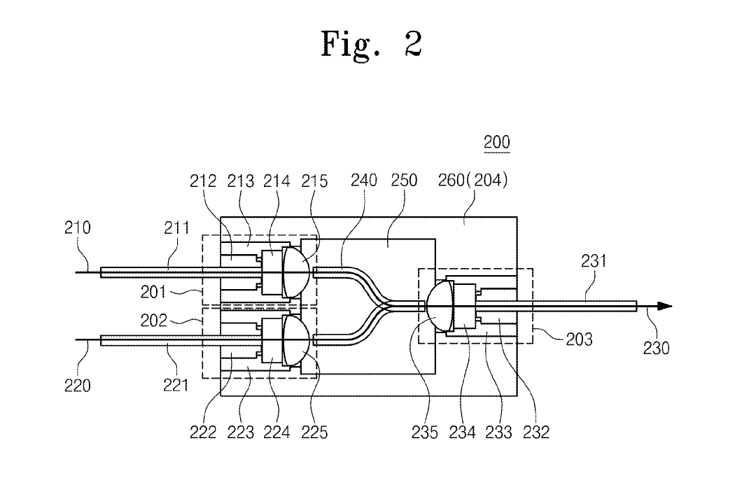

FIG. 2 is a view of an optical fiber connection apparatus coupling and distributing the optical fibers according to an embodiment of the present invention.

Referring to FIG. 2, an optical fiber connection apparatus 200 connects a first optical fiber 211 and a second optical fiber 221 to a third optical fiber 231. Light 210 and 220 incident through the first and second optical fibers 211 and 221 and light 230 emitted through the third optical fiber 231 are shown in FIG. 2. Here, the first and second optical fibers 211 and 221 may be input optical fibers that receive light, and the third optical fiber 231 may be an output optical fiber that emits light.

The optical fiber connection apparatus 200 may include a first input terminal 201, a second input terminal 202, an output terminal 203, and a module coupling unit 204.

The first input terminal 201 may include a first ferrule 212, a first ferrule lens coupling guide 213, a first focus space 214, and a first lens 215.

The first ferrule 212 is used to align core wires of the first optical fiber 211. The first ferrule 212 should have high deformation resistance to maintain its proper shape. Thus, the first ferrule 212 may be formed of stainless steel, polymer, or ceramic (e.g. aluminum oxide or zirconium oxide). Here, since the first optical fiber 211 is inserted into the first ferrule 212, and then the first ferrule 212 receives light through the first optical fiber 211, the first ferrule 212 may be an input ferrule.

The first ferrule lens coupling guide 213 may couple the first ferrule 212 to the first lens 215.

The first focus space 214 may be a space defined between the first ferrule 212 and the first lens 215. The first focus space 214 may be a space for transmitting light emitted from the first optical fiber 211 to the first lens 215 to define a focus by using the first lens 215.

The first lens 215 may concentrate light incident through the first focus space 214 to define a focus. The first lens 215 may emit light incident from the first optical fiber 211 through the defined focus. Since the first lens 215 is disposed in the first input terminal 201, the first lens 215 may be an input lens.

The second input terminal 202 may include a second ferrule 222, a second ferrule lens coupling guide 223, a second focus space 224, and a second lens 225.

The second ferrule 222 is used to align core wires of the second optical fiber 221. The second ferrule 222 should have high deformation resistance to maintain its proper shape. Thus, the second ferrule 222 may be formed of stainless steel, polymer, or ceramic (e.g. aluminum oxide or zirconium oxide). Here, since the second optical fiber 221 is inserted into the second ferrule 222, and then the second ferrule 222 receives light through the first optical fiber 221, the second ferrule 222 may be an input ferrule.

The second ferrule lens coupling guide 223 may couple the second ferrule 222 to the second lens 225.

The second focus space 224 may be a space defined between the second ferrule 222 and the second lens 225. The second focus space 224 may be a space for transmitting light emitted from the second optical fiber 221 to the second lens 225 to define a focus by using the second lens 225.

The second lens 225 may concentrate light incident through the second focus space 224 to define a focus. The second lens 225 may emit light incident from the first optical fiber 221 through the defined focus. Since the second lens 225 is disposed in the second input terminal 202, the second lens 225 may be an input lens.

The output terminal 203 may include a third ferrule 232, a third ferrule lens coupling guide 233, a third focus space 234, and a third lens 235.

The third lens 235 may receive light emitted through an optical waveguide 240. The light scattered through the third lens 235 may be focused. Since the third lens 235 is disposed in the output terminal 203, the third lens 235 may be an output lens.

The third focus space 234 may be a space defined between the third lens 235 and the third ferrule 232. The third focus space 234 may be a space for transmitting the light focused by the third lens 235 to the third optical fiber 231.

The third ferrule lens coupling guide 233 may couple the third ferrule 232 to the third lens 235.

The third ferrule 232 is used to align core wires of the third optical fiber 231. The third ferrule 232 should have high deformation resistance to maintain its proper shape. Thus, the third ferrule 232 may be formed of stainless steel, polymer, or ceramic (e.g. aluminum oxide or zirconium oxide). Here, since the third optical fiber 231 is inserted into the third ferrule 232, and then the third ferrule 232 emits light into the third optical fiber 231, the third ferrule may be an output ferrule.

The module coupling unit 204 may include the optical waveguide 240, a module lower structure 250, and a main module 260. The module coupling unit 204 may include the rest units except for the first input terminal 201, the second input terminal 202, and the output terminal 203 in the optical connection apparatus 200.

The optical waveguide 240 may couple light incident through the first lens 215 and the second lens 225. The optical waveguide 240 may couple light incident through the two lenses 215 and 225 to emit the coupled light into the third lens 235. The optical waveguide 240 may have a Y-branch shape, but the present invention is not limited thereto. For example, the optical waveguide 240 may have various shapes. Furthermore, a plurality of optical waveguides may be provided to provide additional input and output terminals.

The module lower structure 250 may function to support the connections among the lenses 215, 225, 235. The module lower structure 250 may also support the optical waveguide 240. That is, the lenses 215, 225, and 235 and the optical waveguide 240 may be coupled to or disposed on the module lower structure 250.

The main module 260 may package the first, second and third ferrule lens coupling guides 213, 223, and 233 and the module lower structure 250.

Here, the structure of the optical fiber connection apparatus 200 is described as an example. Alternatively, light 230 incident through the third optical fiber 231 may be emitted as the light 210 and 220 incident through the first optical fiber 211 and the second optical fiber 221.

Also, the first optical fiber 211, the second optical fiber 221, and the third optical fiber 231 may be provided with large-core optical fibers, respectively. In this case, the third optical fiber 231 may be an input optical fiber that receives light, and the first optical fiber 211 and the second optical fiber 211 may be output optical fibers that emit light.

The optical waveguide 240 receiving light through the third lens 235 may distribute the received light to emit the light into the first lens 215 and the second lens 225. Here, the output terminal 203 may function as an input terminal, and the first input terminal 201 and the second input terminal 202 may function as first and second output terminals, respectively.

The optical fiber connection apparatus 200 may function as an optical coupling distribution module which couples at least two light to emit at least one light or distributes at least one light to emit at least two light.

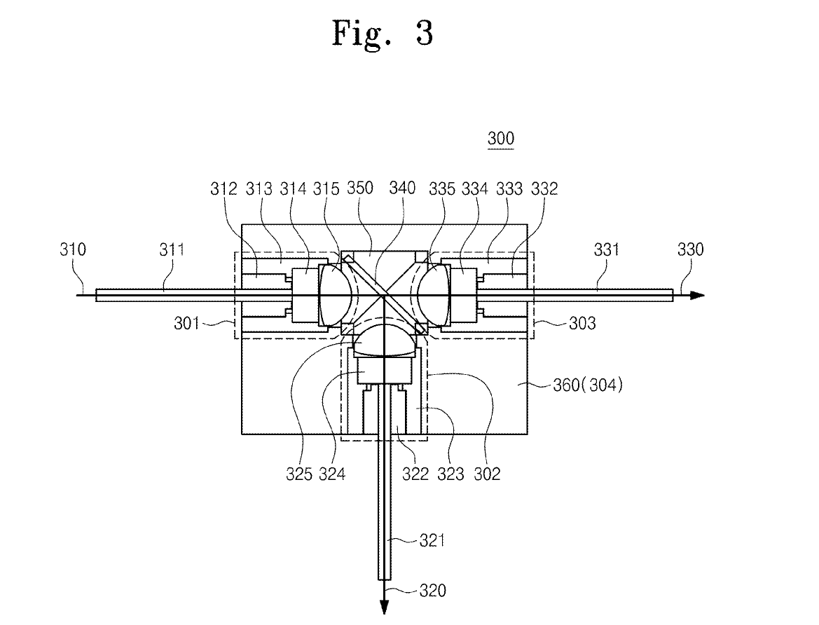

FIG. 3 is a view of an optical fiber connection apparatus distributing solar-light of an optical fiber according to an embodiment of the present invention.

Referring to FIG. 3, an optical fiber connection apparatus 300 connects a first optical fiber 311 to a second optical fiber 321 and a third optical fiber 331. Here, light 310 incident through the first optical fiber 311 and light 320 and 330 emitted through the second and third optical fibers 321 and 331 are shown in FIG. 3. Here, a structure of the optical fiber connection apparatus 300 is described as an example. Each of the first optical fiber 311, the second optical fiber 321, and the third optical fiber 331 may be provided with a large-core optical fiber. Here, the first optical fiber 311 may be an input optical fiber that receives light, and the second optical fiber 321 and the third optical fiber 331 may be output optical fibers that emit light.

The optical fiber connection apparatus 300 may include an input terminal 301, a first output terminal 302, a second output terminal 303, and a module coupling unit 304.

The input terminal 301 may include a first ferrule 312, a first ferrule lens coupling guide 313, a first focus space 314, and a first lens 315.

The first ferrule 312 is used to align core wires of the first optical fiber 311. The first ferrule 312 should have high deformation resistance to maintain its proper shape. Thus, the first ferrule 312 may be formed of stainless steel, polymer, or ceramic (e.g. aluminum oxide or zirconium oxide). Here, since the first optical fiber 311 is inserted into the first ferrule 312, and then the first ferrule 312 receives light through the first optical fiber 311, the first ferrule may be an input ferrule.

The first ferrule lens coupling guide 313 may couple the first ferrule 312 to the first lens 315.

The first focus space 314 may be a space defined between the first ferrule 312 and the first lens 315. The first focus space 314 may be a space for transmitting light emitted from the first optical fiber 311 to the first lens 315 to define a focus by using the first lens 315.

The first lens 315 may concentrate light incident through the first focus space 314 to define a focus. The first lens 315 may emit light incident from the first optical fiber 311 through the defined focus. Since the first lens 315 is disposed in the input terminal 301, the first lens 315 may be an input lens.

The first output terminal 302 may include a second ferrule 322, a second ferrule lens coupling guide 323, a second focus space 324, and a second lens 325.

The second lens 325 may receive light emitted through a distribution filter 340. The light scattered through the second lens 325 may be focused. Since the second lens 325 is disposed in the output terminal 302, the second lens 325 may be an output lens.

The second focus space 324 may be a space defined between the second lens 325 and the second ferrule 322. The second focus space 324 may be a space for transmitting the light focused by the second lens 325 to the second optical fiber 321.

The second ferrule lens coupling guide 323 may couple the second ferrule 322 to the second lens 325.

The second ferrule 322 is used to align core wires of the second optical fiber 321. The second ferrule 322 should have high deformation resistance to maintain its proper shape. Thus, the second ferrule 322 may be formed of stainless steel, polymer, or ceramic (e.g. aluminum oxide or zirconium oxide). Here, since the second optical fiber 321 is inserted into the second ferrule 322, and then the second ferrule 322 emits light into the second optical fiber 321, the second ferrule may be an output ferrule.

The second output terminal 303 may include a third ferrule 332, a third ferrule lens coupling guide 333, a third focus space 334, and a third lens 335.

The third lens 335 may receive light emitted through the distribution filter 340. The light scattered through the third lens 335 may be focused. Since the third lens 335 is disposed in the output terminal 303, the third lens 335 may be an output lens.

The third focus space 334 may be a space defined between the third lens 335 and the third ferrule 332. The third focus space 334 may be a space for transmitting the light focused by the third lens 335 to the third optical fiber 331.

The third ferrule lens coupling guide 333 may couple the third ferrule 332 to the third lens 335.

The third ferrule 332 is used to align core wires of the third optical fiber 331. The third ferrule 332 should have high deformation resistance to maintain its proper shape. Thus, the third ferrule 332 may be formed of stainless steel, polymer, or ceramic (e.g. aluminum oxide or zirconium oxide). Here, since the third optical fiber 331 is inserted into the third ferrule 332, and then the third ferrule 332 emits light into the third optical fiber 331, the third ferrule may be an output ferrule.

The module coupling unit 304 may include the distribution filter 340, a module lower structure 350, and a main module 360.

The distribution filter 340 may distribute light incident through the first lens 315. That is, the distribution filter 340 may distribute light incident through the first lens 315 to emit the distributed light into the second lens 325 and the third lens 335. Thus, the distribution filter 340 may distribute the light received therein to emit at least two light.

The module lower structure 350 may function to support the connections among the lenses 315, 325, and 335. The module lower structure 350 may also support the distribution filter 340. That is, the lenses 315, 325, and 335 and the distribution filter 340 may be coupled to or disposed on the module lower structure 350.

The main module 360 may package the first, second, and third ferrule lens coupling guides 313, 323, and 333 and the module lower structure 350.

The optical fiber connection apparatus 300 may function as an exclusive optical distribution module which distributes at least one light to emit at least two light. In this case, the first optical fiber 311 may receive light, and the second optical fiber 321 and the third optical fiber 331 may emit light.

The number of input terminal (a portion through which an optical signal is inputted) and the number of output terminal (a portion through which an optical signal is outputted) in each of the optical fiber connection apparatuses 100, 200, and 300 that are proposed in the present invention are exemplified as described above, but the present invention is not limited thereto. For example, the number of the input and output terminals may increase.

For example, each of the ferrules 112, 122, 212, 222, 232, 312, 322, and 332 may has a cylindrical structure having an inner hole, in which an optical fiber is inserted, surrounding a surface of the optical fiber. However, the ferrules 112, 122, 212, 222, 232, 312, 322, and 332 each having the cylindrical structure in section are merely an example. Thus, each of the ferrules 112, 122, 212, 222, 232, 312, 322, and 332 may have various shapes in section such as triangular, rectangular, pentagonal, and hexagonal shapes. Further, each of the ferrules 112, 122, 212, 222, 232, 312, 322, and 332 may be formed of a metal material having high heat conductivity.

Heat may be generated at cut ends of the optical fibers, which collects and transmits solar light, by the concentrated solar light. The heat may deform the optical fibers to cause transmission loss. Thus, the ferrules 112, 122, 212, 222, 232, 312, 322, 332 may dissipate the heat to prevent the ends of the optical fibers from being deformed.

Also, the ferrules 112, 122, 212, 222, 232, 312, 322, and 332 may protect an outer appearance of an optical fiber, and also improve transmission efficiency.

The ferrule lens coupling guides 113, 123, 213, 223, 233, 313, 323, and 333 may be directly couplable or separable by a user to connect each of the ferrules 112, 122, 212, 222, 232, 312, 322, and 332 to one side thereof. Here, each of the ferrule lens coupling guides 113, 123, 213, 223, 233, 313, 323, and 333 may be coupled or separated through locking/unlocking thereof. Each of the lenses 115, 125, 215, 225, 235, 315, 325, and 335 may be mounted on the other side of each of the ferrule lens coupling guides 113, 123, 213, 223, 233, 313, 323, and 333.

In the optical fiber connection apparatuses 100, 200, and 300 according to the present invention, the lenses 115, 125, 215, 225, 235, 315, 325, and 335 may be omitted when light passing through the optical fiber is well focused.

As described above, in the optical fiber connection apparatuses 100, 200, and 300 according to the present invention, the connection structure between the optical fibers may be provided to easily connect and separate the optical fibers to/from each other even though the distance for transmitting the sun light increases. Thus, the number of optical fibers for remote transmission may be reduced to easily transmit the sun light.

According to the optical fiber connection apparatus of the present invention, the optical fibers for transmitting the solar light may be connected, coupled, and distributed to each other to transmit the solar light into a required space therethrough. In addition, the optical fibers may be connected, coupled, and distributed to each other to easily connect or separate optical cables constituted by the optical fibers to/from each other.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An apparatus for connecting an optical fiber, the apparatus comprising:
an input terminal in which an input optical fiber receiving light is inserted through an input ferrule;
an output terminal emitting the light incident through the input optical fiber into an outer optical fiber through an output ferrule; and
a module coupling unit connecting the input terminal to the output terminal.

2. The apparatus of claim 1, wherein the input optical fiber is inserted into the input ferrule having a cylindrical structure, and the output optical fiber is inserted into the out ferrule having a cylindrical structure.

3. The apparatus of claim 1, wherein the input terminal comprises:
an input lens defining a focus of the light emitted through the input optical fiber; and
a ferrule lens coupling guide connecting the input ferrule to the input lens.

4. The apparatus of claim 3, wherein a focus space is defined between the input ferrule and the input lens.

5. The apparatus of claim 3, wherein the output terminal comprises:
an output lens defining a focus through which the light is transmitted into the output optical fiber; and
a ferrule lens coupling guide connecting the output lens to the output ferrule.

6. The apparatus of claim 5, wherein a focus space is defined between the output ferrule and the output lens.

7. The apparatus of claim 5, further comprising:
a module lower structure coupling the input lens to the output lens; and
a main module coupling the ferrule lens coupling guides of the input terminal and the output terminal to each other.

8. The apparatus of claim 5, wherein the module coupling unit comprises an optical waveguide which, when at least two input terminals are provided, couples light received through the input terminals to emit the coupled light into the output terminal, and when at least two output terminals are provided, distributes he light received through the input terminal to emit the distributed light into the output terminals.

9. The apparatus of claim 7, wherein the optical waveguide has a Y-shape.

10. The apparatus of claim 7, wherein the module coupling unit further comprises:
a module lower structure coupling the lens of the input terminal, the lens of the output terminal, and the optical waveguide to each other; and
a main module coupling the module lower structure to the ferrule lens coupling guides of the input and output terminals.

11. The apparatus of claim 5, wherein the module coupling unit comprises a distribution filter which, when at least two output terminals are provided, distributes light received through the output terminals to emit the distributed light into the output terminal.

12. The apparatus of claim 5, wherein the module coupling unit further comprises:
a module lower structure coupling the lens of the input terminal, the lens of the output terminal, and the distribution filter to each other; and
a main module coupling the module lower structure to the ferrule lens coupling guides of the input and output terminals.

13. The apparatus of claim 1, wherein the optical fiber comprises a large-core optical fiber.
